(19) United States
(12) Patent Application Publication
(10) Pub. No.: US 2025/0093601 A1
(43) Pub. Date: Mar. 20, 2025

(54) PREFERENTIAL SEPARATION RIBBON STRUCTURES THAT ARE STRUCTURALLY CONFIGURED TO PROVIDE ENHANCED CABLE MANAGEMENT PERFORMANCE

(71) Applicant: BELDEN INC., St. Louis, MO (US)

(72) Inventor: James John ZIMNICKI, Richmond, IN (US)

(73) Assignee: BELDEN INC., St. Louis, MO (US)

(21) Appl. No.: 18/890,269

(22) Filed: Sep. 19, 2024

Related U.S. Application Data
(60) Provisional application No. 63/539,275, filed on Sep. 19, 2023.

(51) Int. Cl. G02B 6/44

(52) U.S. Cl. CPC G02B 6/4403

(57) ABSTRACT

Multi-conductor ribbon structures may be structurally configured to reduce cable installation time. Such ribbon structures may include an adjacent conductor portion and a bonding portion that may be structurally configured to surround at least a conductor portion of the adjacent conductor portion. The adjacent conductor portion may be partially or wholly surrounded by a coating portion having an outer surface portion. The bonding portion may form a separation portion between the outer surface of each of the adjacent conductors. The separation portion may include a reduced amount of the bonding material adjacent to a first portion of the adjacent conductor portion relative to an amount of the bonding material portion adjacent a second portion of the adjacent conductor portion so as to provide a preferential separation region between the adjacent conductor portion at the first portion of the adjacent conductor portion. The bonding portion may be structurally configured to preferentially detach, or separate at the preferential separation region in predetermined, uniform, or controlled manner, in response to a force that urges the first and second conductor portions of the adjacent conductor portion away from one another.

### CROSS-REFERENCE TO RELATED APPLICATION

This application claims the benefit of U.S. Provisional Application No. 63/539,275, filed Sep. 19, 2023, the disclosure of which is hereby incorporated by reference herein in its entirety.

### FIELD

The present application generally relates to multi-conductor ribbon structures that may be structurally configured to provide enhanced cable management performance. For instance, the present application may relate to multi-conductor optical fiber ribbon structures that may be structurally configured to include a preferential, predetermined, uniform, controlled, and/or non-varying separation region between the adjacent conductors or fibers so as to reduce the overall splicing time or termination time by concentrating bonding residue on a predetermined and/or preferential conductor portion eliminating or limiting cleaning time and/or prevent damage to the optical fiber. By way of further example, the present application may relate to a multi-conductor optical fiber ribbon configuration that may include a separation portion of bonding material between adjacent conductors or fibers of the ribbon configuration that may be structurally configured to provide a preferential ad/or predetermined separation region between the adjacent conductors or fibers that reduces the overall splicing time or termination time by concentrating bonding residue on a predetermined and/or preferential conductor portion eliminating or limiting cleaning time and/or prevent damage to the optical fiber.

As another example, a multi-conductor copper cable, for example, including one or more bonded pairs, may include a separation portion of bonding material between adjacent conductors of the ribbon configuration that may be structurally configured to provide predetermined, uniform, and/or nonvarying impedance and/or cross-take attenuation performance.

### BACKGROUND

Ribbon cables, which may be referred to as multi-wire planar cables, include a plurality of conductors attached to each other in a plane, and may include glass optical fibers, plastic optical fibers, air core fibers, or other conductors. Typically, ribbon cables may be embedded in or attached by a dielectric material, such as UV-cured materials, such as acrylate, epoxy, polyester, silicone, or styrene copolymer based materials. For example, multi-fiber ribbons may comprise six or twelve optical fibers (or any other number) attached to each other in planar configuration as a ribbon, allowing for faster splicing or termination in many instances.

Ribbon cables may be separated at a terminal portion for splicing or termination (e.g., into connectors, terminal blocks, or other equipment). This may involve splitting or separating the dielectric material in order to separate the individual conductors or fibers. However, the dielectric material may not be perfectly or symmetrically split between two adjacent conductors or fibers, such that a majority of the material may randomly end up attached to one of the conductors or fibers or the other. This may result in the unpredictable nature in which the break occurs along featureless bonds, thus resulting in damage to the optical fibers, unpredictable, non-uniform, and/or additional difficulty in cleaning fibers.

In the case of copper cables, if the dielectric material is not perfectly or symmetrically split between two adjacent conductors, such that a majority of the material may randomly end up attached to one of the conductors or the other, electrical performance may be negatively affected.

### SUMMARY

According to various exemplary aspects of the disclosure, a multi-conductor configured to reduce the overall termination time by concentrating bonding residue on a predetermined and/or preferential conductor portion to reduce cleaning time and/or prevent damage to the optical fiber may include a first conductor portion, a second conductor portion adjacent to the first conductor portion, and a bonding portion structurally configured to partially or wholly surround at least a portion of the first conductor portion and the second conductor portion so as to couple the first conductor portion with the second conductor portion. The first conductor portion may comprise an optical fiber that is structurally configured to be surrounded by at least a portion of a coating having an outer surface portion, and the bonding portion may include a separation portion located between the outer surface portion and the second conductor portion. The bonding portion may comprise a bonding material, and the separation portion may be structurally configured to lack lateral symmetry between the first conductor portion and the second conductor portion. The separation portion may be structurally configured to include a reduced amount of the bonding material located adjacent to the first conductor portion relative to an amount of the bonding material adjacent the second conductor portion so as to provide a preferential separation region between the first conductor portion and the second conductor portion oat the first conductor portion. The bonding portion may be structurally configured to preferentially detach or separate at the preferential separation region in a predetermined manner, in response to a separation force that urges the first conductor portion away from the second conductor portion so as to reduce cleaning times for termination by concentrating bonding residue on a predetermined and/or preferential conductor portion and/or prevent damage to the optical fiber.

According to various aspects of the aforementioned multi-conductor ribbon, the preferential detachment or separation at the preferential separation region may be structurally configured to provide average performance and optical attenuation characteristics between the individual conductors.

According to various aspects of any of the aforementioned multi-conductor ribbons, the separation portion may be structurally configured to be symmetrical in a direction perpendicular to the lateral direction. Alternatively, according to various aspects of any of the aforementioned multi-conductor ribbons, the separation portion may be structurally configured to lack symmetry in a direction perpendicular to the lateral direction.

According to various aspects of any of the aforementioned multi-conductor ribbons, the first conductor portion may comprise a first optical fiber and wherein the second conductor portion comprises a second optical fiber.

According to various aspects, any of the aforementioned multi-conductor ribbons, may comprise an additional conductor portion adjacent to the second conductor portion. The additional conductor portion may comprise an optical fiber that is configured to be at least partially surrounded by a coating portion having an outer surface portion. The bonding portion may include a second separation portion between the outer surface portion of the additional conductor portion and the outer surface portion of the second conductor portion, and the second separation portion may include a reduced amount of the bonding material adjacent to the additional conductor portion relative to the amount of the bonding material adjacent the second conductor portion so as to provide a second preferential separation region between the additional conductor portion and the second conductor portion. The bonding portion may be structurally configured to preferentially detach, or separate, at the second preferential separation region in a predetermined manner, in response to a separation force that urges the additional conductor portion and the second conductor portion away from one another so as to reduce cleaning times for installation (e.g., splicing and/or termination) by concentrating bonding residue on predicted and/or preferential conductors and/or prevent damage to the optical fibers.

According to various aspects of the aforementioned multi-conductor ribbon, the second conductor portion comprises a second optical fiber, and the additional conductor portion comprises a third optical fiber.

According to various exemplary aspects of the disclosure, a multi-conductor configured to reduce the overall termination time by concentrating bonding residue on a predetermined and/or preferential conductor portion to reduce cleaning time and/or prevent damage to the optical fiber may include an adjacent fiber portion and a bonding portion that may be structurally configured to partially or wholly surround the adjacent fiber portion. The adjacent conductor portion may include an optical fiber that is structurally configured to be surrounded by at least a portion of a coating having an outer surface portion, and the bonding portion may include a separation portion located between the outer surface portion of the adjacent conductor portion. The bonding portion may comprise a bonding material. The separation portion may be structurally configured to include a reduced amount of the bonding material located adjacent to a first portion of the adjacent conductor portion relative to an amount of the bonding material adjacent a second portion of the adjacent conductor portion so as to provide a preferential separation region between the first portion and the second portion of the adjacent conductor portion at the first portion of the adjacent conductor portion. The bonding portion may be structurally configured to preferentially detach or separate at the preferential separation region in a predetermined manner, in response to a separation force that urges one or more conductor portions of the adjacent conductor portion away from one another, so as to reduce the cleaning time for termination by concentrating bonding residue on a predetermined and/or preferential conductor portion and/or prevent damage to the optical fiber.

According to various aspects of the aforementioned multi-conductor ribbon, the preferential detachment or separation at the preferential separation region may be structurally configured to provide average performance and optical attenuation characteristics between the individual conductors.

According to various aspects of any of the aforementioned multi-conductor ribbons, the separation portion may be structurally configured to lack lateral symmetry between the adjacent conductors.

According to various aspects of any of the aforementioned multi-conductor ribbons, the separation portion may be structurally configured to be symmetrical in a direction perpendicular to the lateral direction.

According to various aspects of any of the aforementioned multi-conductor ribbons, the separation portion may be structurally configured to lack symmetry in a direction perpendicular to the lateral direction.

According to various aspects of any of the aforementioned multi-conductor ribbons, the first portion of the adjacent conductor portion may comprise a first conductor and wherein the second portion of the adjacent conductor portion comprises a second conductor.

According to various aspects of any of the aforementioned multi-conductor ribbons, the first conductor may comprise a first optical fiber and the second conductor comprises a second optical fiber.

According to various aspects, any of the aforementioned multi-conductor ribbons may comprise an additional conductor adjacent to the second portion of the adjacent conductor portion. The additional conductor may comprise an optical fiber that is configured to be at least partially surrounded by a coating portion having an outer surface portion, the bonding portion may include a second separation portion between the outer surface portion of the additional conductor portion and the outer surface portion of the second portion of the adjacent conductor portion, and the second separation portion may include a reduced amount of the bonding material adjacent to the additional conductor portion relative to the amount of the bonding material adjacent the second portion of the adjacent conductor portion so as to provide a second preferential separation region between the additional conductor portion and the second portion of the adjacent conductor portion. The bonding portion is structurally configured to preferentially detach, or separate, at the second preferential separation region in a predetermined manner, in response to a separation force that urges the additional cable and the second one of the adjacent cables away from one another so as to reduce cleaning times for installation (e.g., splicing and/or termination) by concentrating bonding residue on predicted and/or preferential conductors and/or prevent damage to the optical fibers.

According to various aspects of any of the aforementioned multi-conductor ribbons, the first portion of the adjacent conductor portion may comprise a first conductor and wherein the second portion of the adjacent conductor portion comprises a second conductor.

According to various exemplary aspects of the disclosure, a multi-conductor configured to reduce the overall termination time by concentrating bonding residue on a predetermined and/or preferential conductor portion to reduce cleaning time and/or prevent damage to the optical fiber may include an adjacent fiber portion and a bonding portion that may be structurally configured to partially or wholly surround the adjacent fiber portion. The adjacent conductor portion may be structurally configured to be surrounded by at least a portion of a coating having an outer surface portion, and the bonding portion may include a separation portion located between the outer surface portion of the adjacent conductor portion. A portion of the bonding portion located adjacent to a first portion of the adjacent conductor portion may be smaller than a portion of the bonding portion adjacent a second portion of the adjacent conductor portion so as to provide a preferential separation region between the first portion and the second portion of the adjacent conductor portion at the first portion of the adjacent conductor portion. The bonding portion may be structurally configured to preferentially detach or separate at the preferential separation region in a predetermined manner, in response to a separation force that urges one or more conductor portions of the adjacent conductor portion away from one another so as to reduce cleaning times for termination by concentrating bonding residue on a predetermined and/or preferential conductor portion and/or prevent damage to the adjacent conductor portion.

According to various aspects of any of the aforementioned multi-conductor ribbons, the preferential detachment or separation at the preferential separation region may be structurally configured to provide average performance and optical attenuation characteristics between the individual conductors.

According to various aspects of any of the aforementioned multi-conductor ribbons, the separation portion may be structurally configured to lack lateral symmetry between the adjacent conductors.

According to various aspects of any of the aforementioned multi-conductor ribbons, the separation portion may be structurally configured to be symmetrical in a direction perpendicular to the lateral direction.

According to various aspects of any of the aforementioned multi-conductor ribbons, the separation portion may be structurally configured to lack symmetry in a direction perpendicular to the lateral direction.

According to various aspects of any of the aforementioned multi-conductor ribbons, the first portion of the adjacent conductor portion may comprise a first conductor and wherein the second portion of the adjacent conductor portion comprises a second conductor.

According to various aspects of any of the aforementioned multi-conductor ribbons, the first conductor may comprise a first optical fiber and the second conductor comprises a second optical fiber.

According to various aspects, any of the aforementioned multi-conductor ribbons may further comprise an additional conductor adjacent to the second portion of the adjacent conductor portion. The additional conductor may be configured to be at least partially surrounded by a coating portion having an outer surface portion, and the bonding portion may include a second separation portion between the outer surface portion of the additional conductor portion and the outer surface portion of the second portion of the adjacent conductor portion. The second separation portion may include a reduced amount of the bonding material adjacent to the additional conductor portion relative to the amount of the bonding material adjacent the second portion of the adjacent conductor portion so as to provide a second preferential separation region between the additional conductor portion and the second portion of the adjacent conductor portion. The bonding portion may be structurally configured to preferentially detach, or separate, at the second preferential separation region in a predetermined manner, in response to a separation force that urges the additional cable and the second one of the adjacent cables away from one another so as to reduce cleaning times for installation (e.g., splicing and/or termination) by concentrating bonding residue on predicted and/or preferential conductors and/or prevent damage to the adjacent and additional conductor portions.

According to various aspects of any of the aforementioned multi-conductor ribbons, the first portion of the adjacent conductor portion may comprise a first conductor and wherein the second portion of the adjacent conductor portion comprises a second conductor

### BRIEF DESCRIPTION OF THE FIGURES

FIGS. 1A and 1B are cross sectional views of a conventional embodiment of a ribbon cable lacking preferential separation;

FIGS. 1C and 1D are cross sectional views of another conventional embodiment of a ribbon cable lacking preferential separation;

FIGS. 2A and 2B are cross sectional views of an exemplary embodiment of a ribbon cable having preferential separation region;

FIG. 2C is a top right perspective view of an exemplary embodiment of a ribbon cable having a preferential separation region;

FIGS. 3A and 3B are cross sectional views of exemplary embodiments of ribbon cables having a preferential separation region;

FIGS. 3C and 3D provide a cross sectional view and a top right perspective view of an exemplary embodiment of a ribbon cable having a preferential separation region; and

FIGS. 4A and 4B provide a cross sectional view and top left perspective view of another exemplary embodiment of a ribbon cable having a preferential separation region.

In the drawings, like reference numbers generally indicate identical, functionally similar, and/or structurally similar elements.

### DETAILED DESCRIPTION

Ribbon cables may be separated at a terminal portion for splicing or termination (e.g., into connectors, terminal blocks, or other equipment). This may involve splitting or separating a bonding material or dielectric between individual cables of the ribbon cable in order to separate the individual conductors or fibers. However, the bonding material or dielectric may not be perfectly or symmetrically split between two adjacent conductors or fibers, such that a majority of the material may randomly end up attached to one of the conductors or fibers or the other. This may result in unpredictable, unreliable, non-uniform and/or otherwise inferior optical performance or additional difficulty in cleaning fibers.

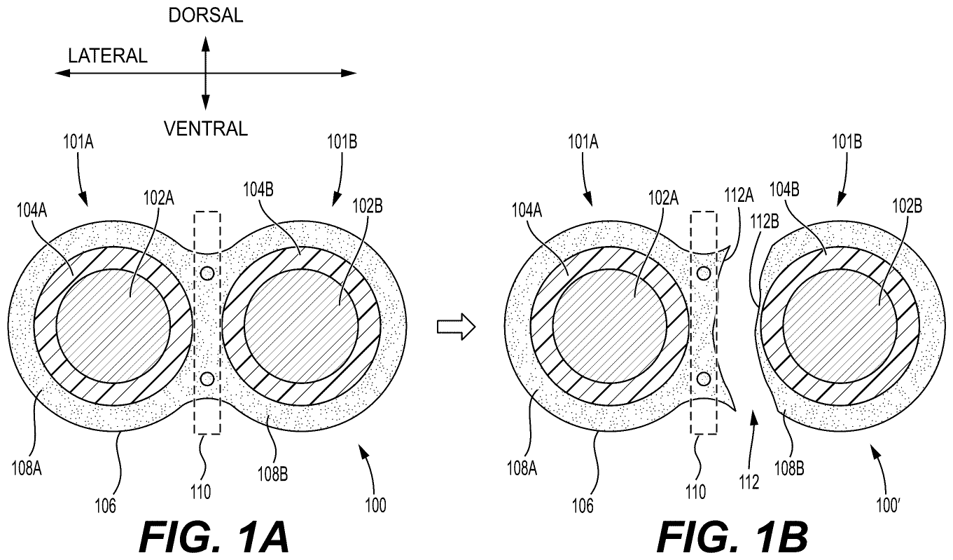

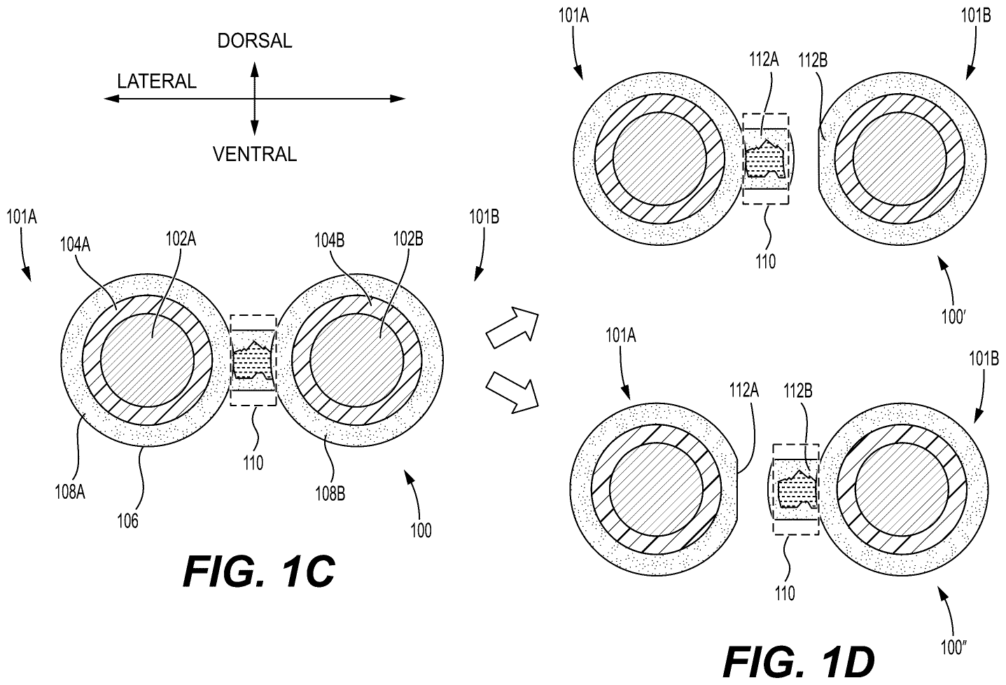

For example, FIGS. 1A and 1B are cross sections of a conventional implementation of a multi-conductor ribbon 100 (before separation) and 100′ (after separation) lacking preferential separation. As shown, the ribbon 100 may comprise a plurality of individual conductors 101A, 101B that are bonded together via a bonding material. The conductors 101A, 101B may include signal transmission portions or optical fibers 102A, 102B, respectively. In some aspects according to the disclosure, instead of fibers, the conductors 101A, 101B may comprise copper wires, including for example bonded pairs of copper wire.

In many implementations, optical fibers 102A, 102B (referred to generally as fibers 102) may be encapsulated in a cover portion 104A, 104B, for example, a coating, which may comprise an insulating or dielectric material, such as polyvinyl chloride (PVC), polytetrafluoroethylene (PTFE or Teflon), polyvinylidene fluoride (PVDF), UV-curable materials including acrylate, epoxy, polyester, silicone, or styrene copolymer based materials, or any other such material. The conductors 101A, 101B may be bonded to one another via a bonding material 106, which may comprise silicone rubber, polyvinyl chloride (PVC), polytetrafluoroethylene (PTFE or Teflon), polyvinylidene fluoride (PVDF), fluorine resin, UV-curable materials including acrylate, epoxy, polyester, silicone, or styrene copolymer based materials, or any other such material, shown as a first portion 108A and a second portion 108B respectively attached to fiber 102A (via coating 104A), and fiber 102B (via coating 104B).

In the implementation shown, the bonding material 106 completely surrounds the coatings 104A, 104B, though in other implementations, less bonding material may be employed. For example, the bonding material may only cover a portion of the coatings 104A, 104B. The bonding material 106 includes a separation portion 110 (shown in dotted line) between the coatings 104A, 104B and/or the fibers 102A, 102B. In many such implementations lacking the preferential separation features discussed herein below, the bonding material 106 is laterally symmetrical around a vertical plane across the ribbon cable as shown. The bonding material also may be vertically symmetrical around a horizontal plane through the ribbon cable as shown (e.g., with identical dorsal and ventral portions). When separating the conductors 101A, 101B, the location of a separation region 112 may vary within the separation portion 110, and the bonding material 106 may unevenly tear or detach from one conductor (as shown in FIG. 1B). As a result of the uneven tearing, the conductors 101A, 101B may require additional cleaning, the fibers may be damaged, the conductors 101A, 101B may be prevented from being inserted into a furcation tube by excess bonding material that may adhere to the furcation tube, unpredictable, non-uniform, and/or otherwise different optical characteristics may occur, such as, for example, distributed or localized attenuation events, between the adjacent conductors, and/or removal of the bonding material or cleaning of the conductors or fibers may be more difficult.

Similarly, FIGS. 1C and 1D are cross sections of another implementation of a ribbon 100 (before separation) and 100′, 100″ (after separation) lacking the preferential separation features discussed herein below. While reducing the amount of bonding material in the separation portion 110 may reduce an amount of bonding residue remaining on one conductor after separation (e.g., 112B in the top version of FIG. 1D, or 112A in the bottom version of FIG. 1D), a corresponding larger amount of bonding material may remain as residue on the other conductor after separation (e.g., 112A in the top version of FIG. 1D, or 112B in the bottom version of FIG. 1D). The positions and amounts of the bonding residues are unpredictable or indeterminate, as shown in FIG. 1D, with the majority potentially ending up on either conductor 101A, 101B.

The present disclosure describes exemplary embodiments for providing multi-conductor optical fiber ribbon structures that may include a preferential and/or predictable separation region. By modifying a profile of a separation portion of bonding material between adjacent conductors of the ribbon or an amount of attachment between the bonding material and the adjacent conductors, the ribbon may be structurally configured such that a majority of the residual bonding material predictably, or in a predetermined or uniform manner, remains on a selected one of the adjacent conductors. This profile may be dynamically varied along a length of the ribbon to provide similar or conforming optical characteristics between adjacent conductors and/or may reduce installation (e.g., splicing and/or termination) or cleaning times by concentrating bonding residue on preferential and/or predicted conductors and/or prevent damage to the optical fibers.

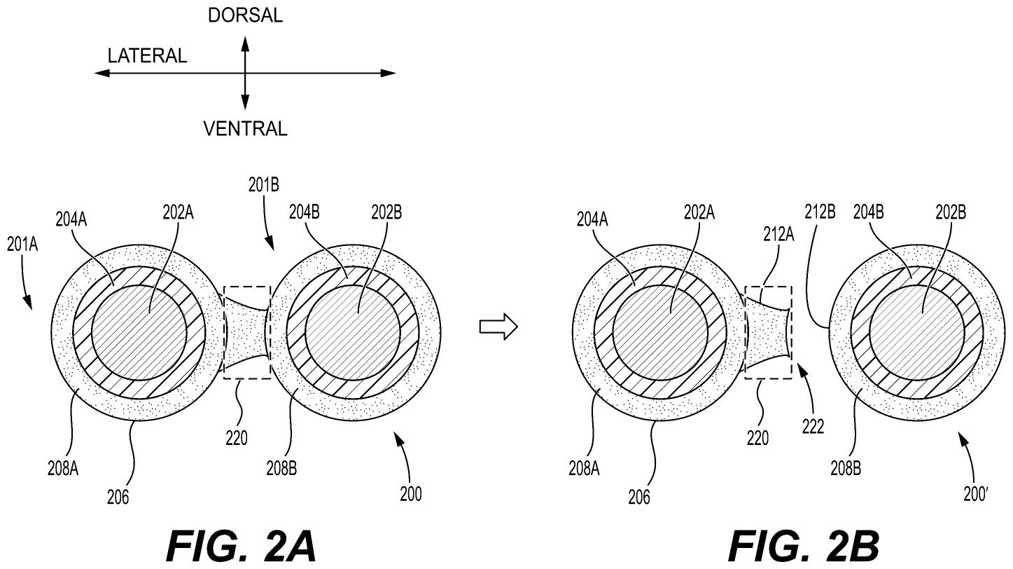

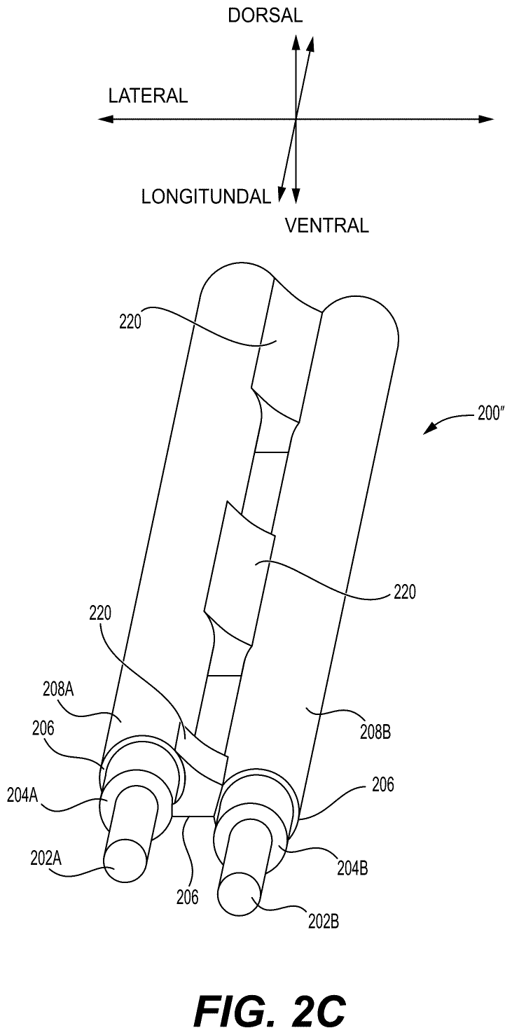

FIGS. 2A and 2B are cross sections of an exemplary embodiment of a multi-conductor optical fiber ribbon 200 (before separation) and 200′ (after separation) that is structurally configured to provide a preferential separation region between adjacent individual conductors 201A, 201B. In the illustrated embodiment, the conductors 201A, 201B may respectively include fibers 202A and 202B with a coating 204A, 204B. The conductors 201A, 201B may partially or wholly surrounded by a bonding material 206 with a first portion 208A and second portion 208B. The bonding material 206 may include a separation portion 220 (alternatively referred to as a bonding area, bonding region, coupling region, coupling structure, or by similar terms). As shown, the separation portion 220 may lack lateral symmetry (although may have vertical symmetry, as in the illustrated embodiment). The separation portion 220 may be structurally configured to provide a preferential separation region 222 between adjacent individual conductors 201A, 201B. For example, because the separation portion 220 has a reduced amount of bonding material 206 adjacent or proximate to conductors 201B (i.e., adjacent to the coating 204B and/or the fiber 202B), the bonding material 206 will predictably detach or separate at the preferential separation region 222 of the separation portion 220 in a predetermined or uniform manner, as shown in FIG. 2B.

While such embodiments of a preferential separation region 222 may still result in different amounts of bonding material on each conductor 201A, 201B after separation, the result is predictable, or in a predetermined, uniformed, controlled, or conforming manner, and may be selected to avoid distributed or localized impairments to optical characteristics or other performance characteristics of the ribbon. For example, the preferential separation region 222 may be structurally configured to predictably, or in a predetermined a manner, leave bonding residue on dark fibers, etc.

Furthermore, the bonding regions need not be continuous longitudinally along the length of the ribbon. FIG. 2C is a top right perspective view of an implementation of a ribbon 200″ having preferential separation with intermittent or non-continuous separation portions 220 of bonding material 206. Such ribbons 200″ may have greater flexibility relative to ribbons with continuous bonding material. Additionally, in some implementations, alternating separation portions along the length of the ribbon may have opposing orientations, such that each adjacent conductor alternately retains the separation portion after separation, resulting in similar average performance and optical attenuation characteristics between the individual conductors 201A, 201B over the separated or unseparated length (which may include a large number of such separation portions, such as implementations where the separation portions are separated by a small amount, e.g., on the order of centimeters, and the separated length of the conductors is significantly longer, e.g., 0.5 meters, 1 meter, or longer). For example, the attenuation effects over hundreds of meters may be better distributed between fibers, or preferentially applied to fibers to compensate for other effects due to position in the ribbon, such as, for example, higher attenuation of edge fibers due to bundling/bunching.

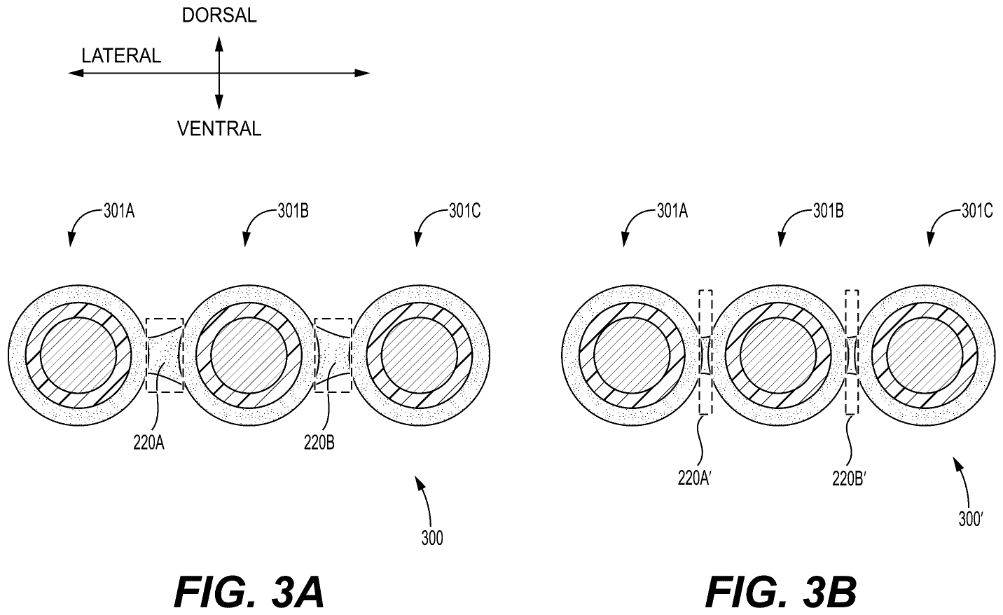

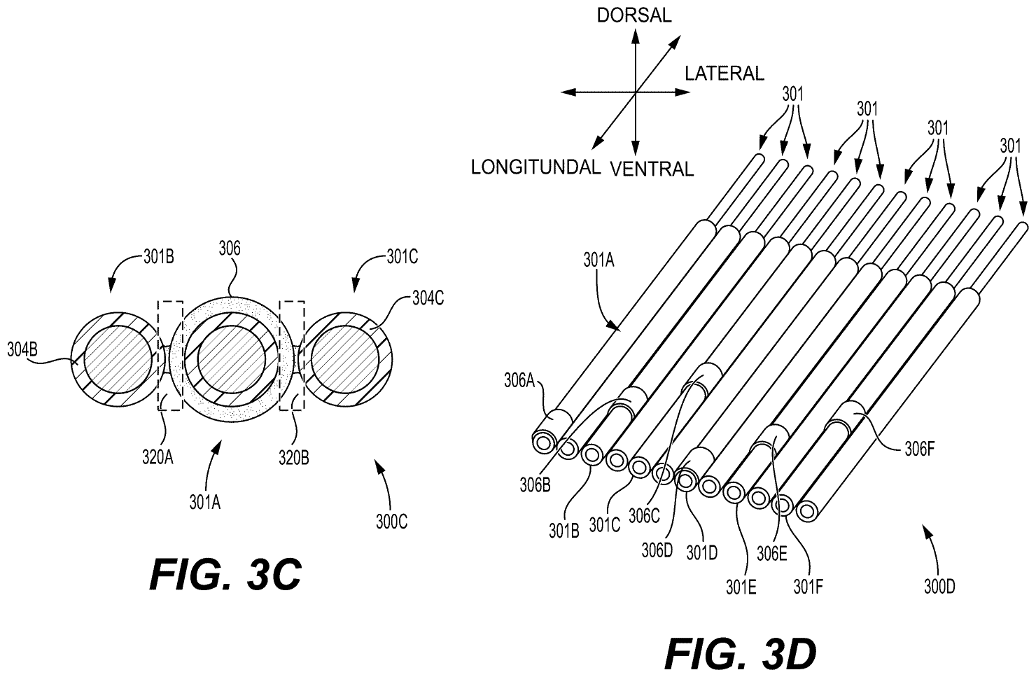

Although shown with only two conductors in FIGS. 2A-2C, bonding material with separation regions may be used throughout larger ribbons (i.e., ribbons having more than two conductors). For example, FIGS. 3A and 3B are cross sections of implementations of ribbons 300, 300′ having separation regions 220A, 220B between individual conductors 301A, 301B, 301C. In both implementations of FIGS. 3A and 3B, each separation region 220A, 220B lacks individual lateral symmetry (though the separation regions 220A, 220B may be laterally symmetric to each other, as shown with region 220A being symmetric with region 220B across a vertical plane through the center conductor). As discussed above, when intermittent or non-continuous separation regions are utilized, the separation regions 220A, 220B need not be located at the same longitudinal position on the ribbon 300, 300′. For example, preferential separation region 220A may be located at a first longitudinal position on the ribbon, and preferential separation region 220B may be located at a second longitudinal position spaced away from the first longitudinal position further along a length of the ribbon. This arrangement may allow for greater flexibility in the ribbon 300, 300″.

While the embodiment of FIG. 3A shows separation regions 220A, 220B having a first dimension in the lateral direction, smaller separation regions 220A′, 220B′ may be used in other embodiments, as shown in FIG. 3B.

In the embodiments of FIGS. 2A-2C and 3A-3B, the bonding material 206 completely surrounds the individual conductors (i.e., the coated fibers). In other embodiments, the bonding material 206 may only partially surround the individual conductors (i.e., the coated fibers). In some embodiments, the bonding material 206 may only be present in the separation region between adjacent individual conductors.

In some embodiments, as shown in FIG. 3C, a bonding material 306 may surround only some of the individual conductors. FIG. 3C is a cross section of such an embodiment of a ribbon 300C having the bonding material 306 surrounding only a center conductor 301A between adjacent conductors 301B, 301C of a group of three conductors. The bonding material 306 may be attached to the coatings 304B, 304C of the adjacent conductors 301B, 301C at separation regions 320A, 320B as shown. The adhesion strength of the bond between the bonding material 306 and the coatings 304B, 304C may be less than the cohesive strength of the bonding material 306, such that the adjacent conductors 301B, 301C may be separated from the center conductors 301A without tearing the bonding material 306.

In a similar embodiment illustrated in FIG. 3D, a ribbon 300D may include a plurality of individual conductors 301, where alternating conductors 301A-301F of the plurality of individual conductors 301 are each surrounded with bonding material 306A-306F at longitudinally separated positions. By alternating high and low adhesion bonds along the length between two adjacent individual conductors, attenuation effects may be distributed between them, reducing or eliminating unpredictability and optical characteristic differences. The bonding of the ribbon 300D may be referred to as a web, as the ribbon may be gently stretched laterally with gaps opening between adjacent individual conductors between the longitudinally separated positions of the bonding material 306A-306F on said adjacent individual conductors. This may improve flexibility of the ribbon relative to fully bonded ribbons, and also speed installation (e.g., splicing and/or termination) by reducing the amount of bonding material present, which may need to be cleaned or removed, in some installation methods. In some embodiments, a ribbon may include longitudinal lengths with no bonds, thereby facilitating ribbon flatness or planarity for ease of fusion splicing or termination of multiple conductors simultaneously.

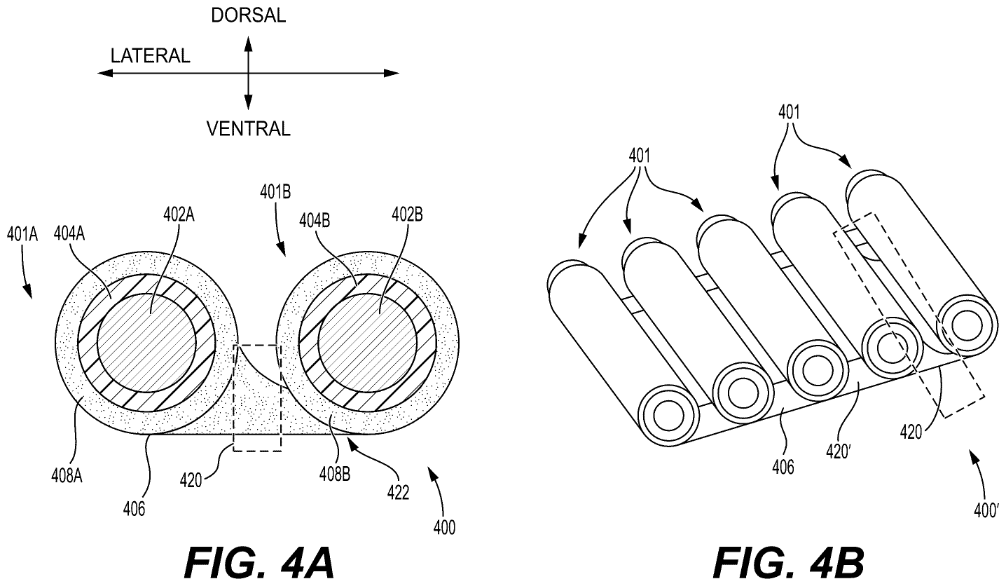

While the embodiments discussed above may comprise a separation portion of bonding material that lacked lateral symmetry but possessed vertical symmetry, other embodiments may lack both lateral and vertical symmetry of the separation portion. For instance, FIGS. 4A and 4B illustrate a cross sectional and top left perspective view of another embodiment of a ribbon 400, 400′ having individual conductors 401A, 401B at least partially covered by a bonding material 406 that includes a first portion 408A and second portion 408B, where the bonding material 406 includes a separation portion 420 configured to provide a preferential separation region 422. As shown, separation portion 420 may be structurally configured to lack any lateral or vertical symmetry, which may allow for a smaller separation portion 420 of bonding material 406 in some implementations. Such implementations also may reduce attenuation effects on a first conductors 401A, which includes a fiber 402A and a coating 404A, that retains the separation portion after separation, as a majority of the material may be moved farther from a center of a second conductor 401B, which includes a fiber 402B and a coating 404B. As shown in the embodiment of FIG. 4B, the separation portions 420, 420′ may be structurally configured differently between each adjacent individual conductor 401. This also may vary along the longitudinal length of the ribbon 400′, such that different individual conductors 401 are easily separated without bonding residue or with minimal residue at different positions.

Accordingly, the embodiments of the ribbons discussed herein provide preferential and/or predictable separation regions between adjacent individual conductors comprising fibers of the ribbons, which may increase installation (e.g., splicing and/or termination) efficiency and reduce optical characteristic differences by distributing effects between different conductors or moving them to dark fibers.

In a first aspect, the present disclosure may be directed to multi-conductor optical fiber ribbon cable structures. Such ribbon cable structures may include a plurality of parallel optical fibers, each fiber being surrounded by a coating having an outer surface. These ribbon cable structures also may include a coupling structure fixed to a first outer surface of a coating of a first optical fiber and a second outer surface of a coating of a second optical fiber of the plurality of optical fibers. A first bonding area between the first outer surface and the coupling structure may be larger than a second bonding area between the second outer surface and the coupling structure.

In some implementations, the coupling structure may be structurally configured to lack lateral symmetry between the first optical fiber and the second optical fiber. In a further implementation, the coupling structure may be structurally configured to lack vertical symmetry between the first optical fiber and the second optical fiber.

In another aspect, the present disclosure may be directed to other types of multi-conductor optical fiber ribbon cable structures. Such other types of ribbon cable structures may include a first coated optical fiber, a second coated optical fiber that may be structurally configured to extend parallel to the first coated optical fiber, and a coupling structure that may be structurally configured to partially or wholly surround the first coated optical fiber and be separately attached to the second coated optical fiber at a bonding surface at a first longitudinal position along the ribbon, the coupling structure may be structurally configured to not surround the second coated optical fiber at the first longitudinal position along the ribbon cable.

In some implementations, such ribbon cable structures may include a third coated optical fiber that may be structurally configured to extend parallel to the second coated optical fiber and the first coated optical fiber, and a second coupling structure that may be configured to partially or wholly surround the third coated optical fiber and be separably attached to the second coated optical fiber at a second bonding surface at a second longitudinal position along the ribbon, and the second coupling structure may be configured to not partially or wholly surround the second coated optical fiber at the second longitudinal position along the ribbon.

Persons skilled in the art would understand that the ribbon structures disclosed herein may be used to create lighter separation forces between adjacent fibers in the absence of solenoid/resin applicators that have short deposit times. The offset and subsequent smaller contact area disclosed herein may create lighter separation forces, which overcomes the need for equipment with shorter opening and closing times and, thus, reduces the cost of the system and replacement parts.

The above description in conjunction with the above-reference drawings sets forth a variety of embodiments for exemplary purposes, which are in no way intended to limit the scope of the described methods or systems. Those having skill in the relevant art can modify the described methods and systems in various ways without departing from the broadest scope of the described methods and systems. Thus, the scope of the methods and systems described herein should not be limited by any of the exemplary embodiments and should be defined in accordance with the accompanying claims and their equivalents.

What is claimed is:

1. A multi-conductor ribbon structure structurally configured to reduce the overall termination time by concentrating bonding residue on a predetermined and/or preferential conductor portion to reduce cleaning time and/or prevent damage to an optical fiber, comprising:
a first conductor portion;
a second conductor portion disposed adjacent to the first conductor portion;
a bonding portion structurally configured to partially or wholly surround at least a portion of the first conductor portion and the second conductor portion;
wherein the first conductor portion comprises an optical fiber that is structurally configured to be surrounded by at least a portion of a coating having an outer surface portion;
wherein the bonding portion includes a separation portion located between the outer surface portion and the second conductor portion;
wherein the bonding portion comprises a bonding material;
wherein the separation portion is structurally configured to lack lateral symmetry between the first conductor portion and the second conductor portion;
wherein the separation portion is structurally configured to include a reduced amount of the bonding material located adjacent to the first conductor portion relative to an amount of the bonding material adjacent the second conductor portion so as to provide a preferential separation region between the first conductor portion and the second conductor portion oat the first conductor portion; and
wherein the bonding portion is structurally configured to preferentially detach or separate at the preferential separation region in a predetermined manner, in response to a separation force that urges the first conductor portion away from the second conductor portion so as to reduce cleaning times for termination by concentrating bonding residue on a predetermined and/or preferential conductor portion and/or prevent damage to the optical fiber.

2. The multi-conductor ribbon of claim 1, wherein the preferential detachment or separation at the preferential separation region is structurally configured to provide average performance and optical attenuation characteristics between the individual conductors.

3. The multi-conductor ribbon of claim 1, wherein the separation portion is structurally configured to be symmetrical in a direction perpendicular to the lateral direction.

4. The multi-conductor ribbon of claim 1, wherein the separation portion is structurally configured to lack symmetry in a direction perpendicular to the lateral direction.

5. The multi-conductor ribbon of claim 1, wherein the first conductor portion comprises a first optical fiber and wherein the second conductor portion comprises a second optical fiber.

6. The multi-conductor ribbon of claim 1, further comprising:
an additional conductor portion adjacent to the second conductor portion;
wherein the additional conductor portion comprises an optical fiber that is configured to be at least partially surrounded by a coating portion having an outer surface portion;
wherein the bonding portion includes a second separation portion between the outer surface portion of the additional conductor portion and the outer surface portion of the second conductor portion;
wherein the second separation portion includes a reduced amount of the bonding material adjacent to the additional conductor portion relative to the amount of the bonding material adjacent the second conductor portion so as to provide a second preferential separation region between the additional conductor portion and the second conductor portion; and
wherein the bonding portion is structurally configured to preferentially detach, or separate, at the second preferential separation region in a predetermined manner, in response to a separation force that urges the additional conductor portion and the second conductor portion away from one another so as to reduce cleaning times for installation by concentrating bonding residue on predicted and/or preferential conductors and/or prevent damage to the optical fibers.

7. The multi-conductor ribbon of claim 6, wherein the second conductor portion comprises a second optical fiber, and wherein the additional conductor portion comprises a third optical fiber.

8. A multi-conductor ribbon structure structurally configured to reduce the overall termination time by concentrating bonding residue on a predetermined and/or preferential conductor portion to reduce cleaning time and/or prevent damage to an optical fiber, comprising:
an adjacent conductor portion;
a bonding portion structurally configured to partially or wholly surround at least a portion of the adjacent conductor portion;
wherein the adjacent conductor portion comprises an optical fiber that is structurally configured to be surrounded by at least a portion of a coating having an outer surface portion;
wherein the bonding portion includes a separation portion located between the outer surface portion of the adjacent conductor portion;
wherein the bonding portion comprises a bonding material;
wherein the separation portion is structurally configured to include a reduced amount of the bonding material located adjacent to a first portion of the adjacent conductor portion relative to an amount of the bonding material adjacent a second portion of the adjacent conductor portion so as to provide a preferential separation region between the first portion and the second portion of the adjacent conductor portion at the first portion of the adjacent conductor portion; and
wherein the bonding portion is structurally configured to preferentially detach or separate at the preferential separation region in a predetermined manner, in response to a separation force that urges one or more conductor portions of the adjacent conductor portion away from one another so as to reduce cleaning times for termination by concentrating bonding residue on a predetermined and/or preferential conductor portion and/or prevent damage to the optical fiber.

9. The multi-conductor ribbon of claim 8, wherein the preferential detachment or separation at the preferential separation region is structurally configured to provide average performance and optical attenuation characteristics between the individual conductors.

10. The multi-conductor ribbon of claim 8, wherein the separation portion is structurally configured to lack lateral symmetry between the adjacent conductors.

11. The multi-conductor ribbon of claim 10, wherein the separation portion is structurally configured to be symmetrical in a direction perpendicular to the lateral direction.

12. The multi-conductor ribbon of claim 10, wherein the separation portion is structurally configured to lack symmetry in a direction perpendicular to the lateral direction.

13. The multi-conductor ribbon of claim 8, wherein the first portion of the adjacent conductor portion comprises a first conductor and wherein the second portion of the adjacent conductor portion comprises a second conductor.

14. The multi-conductor ribbon of claim 13, wherein the first conductor comprises a first optical fiber and the second conductor comprises a second optical fiber.

15. The multi-conductor ribbon of claim 8, further comprising:
an additional conductor adjacent to the second portion of the adjacent conductor portion;
wherein the additional conductor comprises an optical fiber that is configured to be at least partially surrounded by a coating portion having an outer surface portion;
wherein the bonding portion includes a second separation portion between the outer surface portion of the additional conductor portion and the outer surface portion of the second portion of the adjacent conductor portion;
wherein the second separation portion includes a reduced amount of the bonding material adjacent to the additional conductor portion relative to the amount of the bonding material adjacent the second portion of the adjacent conductor portion so as to provide a second preferential separation region between the additional conductor portion and the second portion of the adjacent conductor portion; and
wherein the bonding portion is structurally configured to preferentially detach, or separate, at the second preferential separation region in a predetermined manner, in response to a separation force that urges the additional cable and the second one of the adjacent cables away from one another so as to reduce cleaning times for installation by concentrating bonding residue on predicted and/or preferential conductors and/or prevent damage to the optical fibers.

16. The multi-conductor ribbon of claim 15, wherein the first portion of the adjacent conductor portion comprises a first conductor and wherein the second portion of the adjacent conductor portion comprises a second conductor.

17. A multi-conductor ribbon structure structurally configured to reduce the overall termination time by concentrating bonding residue on a predetermined and/or preferential conductor portion to reduce cleaning time and/or prevent damage to a conductor, comprising:
an adjacent conductor portion;
a bonding portion structurally configured to partially or wholly surround at least a portion of the adjacent conductor portion;
wherein the adjacent conductor portion is structurally configured to be surrounded by at least a portion of a coating having an outer surface portion;
wherein the bonding portion includes a separation portion located between the outer surface portion of the adjacent conductor portion;
wherein a portion of the bonding portion located adjacent to a first portion of the adjacent conductor portion is smaller than a portion of the bonding portion adjacent a second portion of the adjacent conductor portion so as to provide a preferential separation region between the first portion and the second portion of the adjacent conductor portion at the first portion of the adjacent conductor portion; and
wherein the bonding portion is structurally configured to preferentially detach or separate at the preferential separation region in a predetermined manner, in response to a separation force that urges one or more conductor portions of the adjacent conductor portion away from one another so as to reduce cleaning times for termination by concentrating bonding residue on a predetermined and/or preferential conductor portion and/or prevent damage to the adjacent conductor portion.

18. The multi-conductor ribbon of claim 17, wherein the preferential detachment or separation at the preferential separation region is structurally configured to provide average performance and optical attenuation characteristics between the individual conductors.

19. The multi-conductor ribbon of claim 17, wherein the separation portion is structurally configured to lack lateral symmetry between the adjacent conductors.

20. The multi-conductor ribbon of claim 19, wherein the separation portion is structurally configured to be symmetrical in a direction perpendicular to the lateral direction.

21. The multi-conductor ribbon of claim 19, wherein the separation portion is structurally configured to lack symmetry in a direction perpendicular to the lateral direction.

22. The multi-conductor ribbon of claim 17, wherein the first portion of the adjacent conductor portion comprises a first conductor and wherein the second portion of the adjacent conductor portion comprises a second conductor.

23. The multi-conductor ribbon of claim 22, wherein the first conductor comprises a first optical fiber and the second conductor comprises a second optical fiber.

24. The multi-conductor ribbon of claim 17, further comprising:
an additional conductor adjacent to the second portion of the adjacent conductor portion;
wherein the additional conductor is configured to be at least partially surrounded by a coating portion having an outer surface portion;
wherein the bonding portion includes a second separation portion between the outer surface portion of the additional conductor portion and the outer surface portion of the second portion of the adjacent conductor portion;
wherein the second separation portion includes a reduced amount of the bonding material adjacent to the additional conductor portion relative to the amount of the bonding material adjacent the second portion of the adjacent conductor portion so as to provide a second preferential separation region between the additional conductor portion and the second portion of the adjacent conductor portion; and
wherein the bonding portion is structurally configured to preferentially detach, or separate, at the second preferential separation region in a predetermined manner, in response to a separation force that urges the additional cable and the second one of the adjacent cables away from one another so as to reduce cleaning times for installation by concentrating bonding residue on predicted and/or preferential conductors and/or prevent damage to the adjacent and additional conductor portions.

25. The multi-conductor ribbon of claim 24, wherein the first portion of the adjacent conductor portion comprises a first conductor and wherein the second portion of the adjacent conductor portion comprises a second conductor.
